(19) United States
(12) Patent Application Publication
(10) Pub. No.: US 2014/0210720 A1
(43) Pub. Date: Jul. 31, 2014

(54) MOUSE DEVICE

(71) Applicant: PRIMAX ELECTRONICS LTD., Taipei (TW)

(72) Inventor: A-Ming Chang, Taipei (TW)

(73) Assignee: Primax Electronics Ltd., Taipei (TW)

(21) Appl. No.: 13/867,637

(22) Filed: Apr. 22, 2013

(30) Foreign Application Priority Data
Jan. 30, 2013 (CN) 201320052797.0

(51) Int. Cl. G06F 3/0354

(52) U.S. Cl. CPC G06F 3/03543
USPC 345/166

(57) ABSTRACT

A mouse device includes a case member, a battery storage box for accommodating a battery, and a ring-shaped cover. The battery storage box is disposed within the case member. Moreover, the battery storage box has an entrance. The entrance is formed in a sidewall of the battery storage box. The ring-shaped cover is connected with the case member from a rear side and a bottom side of the case member for covering the entrance. Due to the structure of the ring-shaped cover, the mouse device has no rotating shaft at the rear end of the case member. Consequently, the length of the case member of the present mouse device is shorter, and the overall volume of the present mouse device is reduced.

### FIELD OF THE INVENTION

The present invention relates to an input device, and more particularly to a mouse device for controlling the movement of a cursor.

### BACKGROUND OF THE INVENTION

The widely-used input device of a computer system includes for example a mouse device, a keyboard device, a trackball device, a touchpad device, or the like. Among these input devices, the mouse device is the most prevailing because it is very easy-to-use for most users. When a mouse device is held by the palm of a user, the user may move the mouse device in order to control a movement of a cursor shown on a display screen of a computer.

Hereinafter, the structures and the functions of a conventional mouse device will be illustrated with reference to FIGS. 1 and 2.

FIG. 1 schematically illustrates the connection between a conventional mouse device and a computer system. The computer system 2 comprises a computer host 21 and a display screen 22. The computer host 21 is in communication with a mouse device 1 and the display screen 22. The computer host 21 has a connecting port 211. A graphic-based window 221 and a cursor 222 are shown on the display screen 22. The conventional mouse device 1 is used for controlling the cursor 222 to have the computer host 21 execute a corresponding command. The conventional mouse device 1 comprises a casing 10, a left button 11, a right button 12, a scroll wheel 13, a connecting wire 14, and a connector 15. The casing 10 is used for supporting a user's palm. When the casing 10 is moved by the user to result in a displacement amount, the mouse device 1 generates a corresponding cursor displacement signal according to the displacement amount. According to the cursor displacement signal, the cursor 222 shown on the display screen 22 is moved by the computer host 21.

The left button 11 is located at a first side of the scroll wheel 13. Moreover, the left button 11 is exposed outside the casing 10 to be depressed or tapped by the user. When the left button 11 is depressed, the conventional mouse device generates a left button signal. Consequently, the computer host 21 executes a command corresponding to the left button signal. Similarly, the right button 12 is located at a second side of the scroll wheel 13. Moreover, the right button 12 is exposed outside the casing 10 to be depressed or tapped by the user. When the right button 12 is depressed, the conventional mouse device generates a right button signal. Consequently, the computer host 21 executes a command corresponding to the right button signal. The scroll wheel 13 is also exposed outside the casing 10. When the scroll wheel 13 is rotated by the user, a scrolling signal is generated in response to rotation of the scroll wheel 13. An end of the connecting wire 14 is connected with the connector 15. Consequently, the above signals may be transmitted from the mouse device 1 through the connecting wire 14. Moreover, after the connector 15 is plugged into the connecting port 211 of the computer host 21, the mouse device 1 is in communication with the computer host 21. Moreover, the connector 15 is a universal series bus (USB) for example.

Since the conventional wheel mouse device 1 is connected with the computer host 21 through the connecting wire 14, the operable range for the user is restricted by the length of the connecting wire 14. In other words, the wire linkage is very troublesome and inconvenient to the user. For solving this drawback, a wireless mouse device is introduced into the market. The wireless mouse device uses a wireless signal transmitter and a wireless signal receiver in replace of the conventional connecting wire. In other words, the use of the wireless mouse device is more convenient. Although the wireless mouse device has no spatial restriction because no physical connecting wire is required, there are still some drawbacks. For example, when the wireless mouse device is operated, the electric power supply of the wireless mouse device becomes problematic. Unlike the wired mouse device, the wireless mouse device has no physical connecting wire to receive electric power from the computer. Generally, the wireless mouse device is equipped with a built-in electric energy storage element such as a battery or a rechargeable battery.

The structures of a conventional wireless mouse device will be illustrated as follows. FIG. 2 is a schematic exploded view illustrating a conventional wireless mouse device. The conventional wireless mouse device 3 comprises a base 31, a battery cover 32, a left button 33, a right button 34, plural battery chambers 35, and plural batteries 36. The functions of the left button 33 and the right button 34 of the conventional wireless mouse device 3 are similar to those of the left button 11 and the right button 12 of the conventional wheel mouse device 1, and are not redundantly described herein. In comparison with the conventional wheel mouse device 1, the left button 33 and the right button 34 are not disposed on the battery cover 32. The base 31 comprises a first hooking structure 311 and a rotating shaft 312. The first hooking structure 311 is disposed on an upper part 313 of the base 31. The rotating shaft 312 is located at a rear end 314 of the base 31. The plural battery chambers 35 are disposed on the base 31. Moreover, plural entrances 351 of the plural battery chambers 35 are located near the rear end 314 of the base 31 for accommodating the plural batteries 36, respectively. Moreover, the plural batteries 36 are used for providing electric power to the conventional wireless mouse device 3.

FIG. 3 is a schematic side view illustrating the conventional wireless mouse device of FIG. 2. Please refer to FIGS. 2 and 3. The battery cover 32 is used for covering the base 31 and sheltering the plural battery chambers 35. The battery cover 32 comprises a second hooking structure 321 and a third hooking structure 322. The second hooking structure 321 is located near a front end 323 of the battery cover 32 and at the position corresponding to the first hooking structure 311 of the base 31. The third hooking structure 322 is located near a rear end 324 of the battery cover 32 and at the position corresponding to the rotating shaft 312 of the base 31. For combining the battery cover 32 and the base 31 together, the third hooking structure 322 of the battery cover 32 is engaged with the rotating shaft 312 of the base 31, so that the battery cover 32 is rotatable relative to the base 31. For accommodating the plural batteries 36 into the plural battery chambers 35, the battery cover 32 is firstly rotated to expose the plural entrances 351 of the plural battery chambers 35 (see FIG. 3), then the plural batteries 36 are introduced into corresponding battery chambers 35, and finally the battery cover 32 is rotated to cover the plural battery chambers 35 and the base 31. At the same time, the second hooking structure 321 of the battery cover 32 and the first hooking structure 311 of the base 31 are engaged with each other in order to prevent detachment of the plural batteries 36 from the corresponding battery chambers 35. Similarly, for removing the plural batteries 36 from the corresponding battery chambers 35, the battery cover 32 is firstly opened, then the plural batteries 36 are removed, and finally the battery cover 32 is closed.

Although the conventional wireless mouse device 3 is capable of acquiring the electric power from the plural batteries 36, the conventional wireless mouse device 3 still has some drawbacks. For example, since the conventional wireless mouse device 3 is equipped with the rotating shaft 312 at the rear end 314 of the base 31, the length of the conventional wireless mouse device 3 is relatively long and the volume of the conventional wireless mouse device 3 fails to be effectively reduced.

Therefore, there is a need of providing a mouse device with a reduced length.

### SUMMARY OF THE INVENTION

The present invention provides a mouse device mouse device with a reduced length.

In accordance with an aspect of the present invention, there is provided a mouse device. The mouse device includes a case member, a circuit board, a battery storage box, and a ring-shaped cover. The circuit board is disposed within the case member. The battery storage box is fixed on the case member and disposed over the circuit board. The battery storage box is electrically connected with the circuit board for accommodating a battery, and the battery and the circuit board are separated from each other by the battery storage box. The battery storage box has an entrance, and the entrance is formed in a sidewall of the battery storage box. The battery is permitted to be transferred through the entrance to be accommodated within the battery storage box, or the battery is permitted to be removed from the battery storage box through the entrance. The ring-shaped cover is connected with the case member from a rear side of the casing and a bottom side of the case member, so that a part of the case member and the entrance are covered by the ring-shaped cover. After the battery is accommodated within the battery storage box, the battery is parallel with the battery storage box. During the battery is transferred through the entrance, an angle is formed between the battery and battery storage box. The angle is smaller than 90 degrees.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the connection between a conventional mouse device and a computer system;

FIG. 2 is a schematic exploded view illustrating a conventional wireless mouse device;

FIG. 3 is a schematic side view illustrating the conventional wireless mouse device of FIG. 2;

FIG. 4 schematically illustrates the connection between a computer system and a mouse device according to an embodiment of the present invention;

FIG. 5 is a schematic exploded view illustrating the mouse device according to the embodiment of the present invention;

FIG. 6 is a schematic exploded view illustrating the mouse device according to the embodiment of the present invention and taken along another viewpoint;

FIG. 7 is a schematic exploded view illustrating the battery storage box and the base of the mouse device according to the embodiment of the present invention;

FIG. 8 is a schematic assembled view illustrating the battery storage box and the base of the mouse device according to the embodiment of the present invention;

FIGS. 9A and 9B are schematic side views illustrating the combination of the case member and the ring-shaped cover of the mouse device according to the embodiment of the present invention; and

FIGS. 10A and 10B are schematic perspective views illustrating a process of installing a battery in the battery storage box of the mouse device according to the embodiment of the present invention.

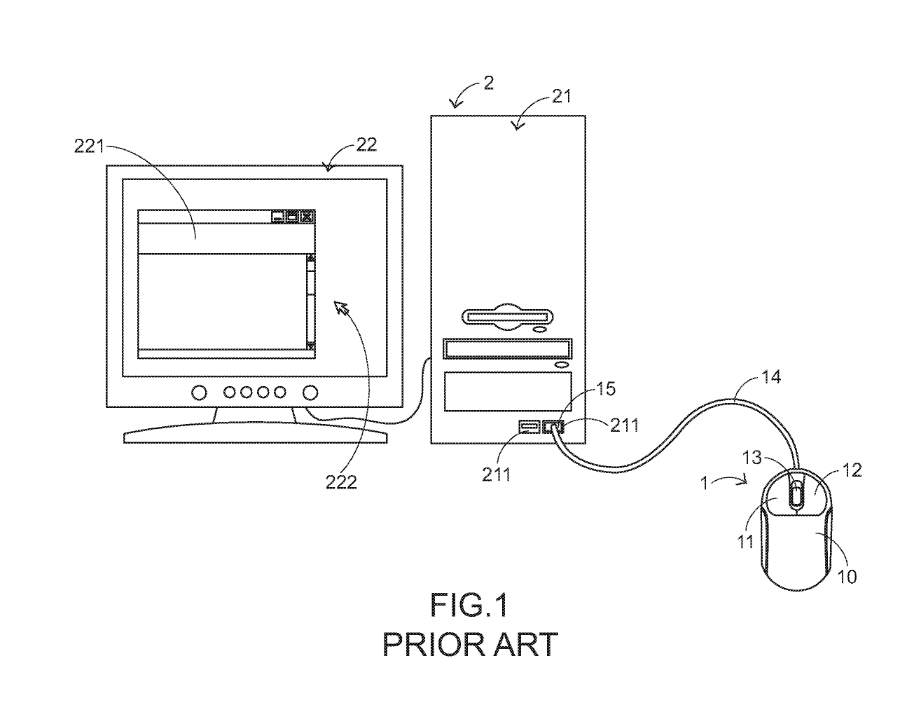

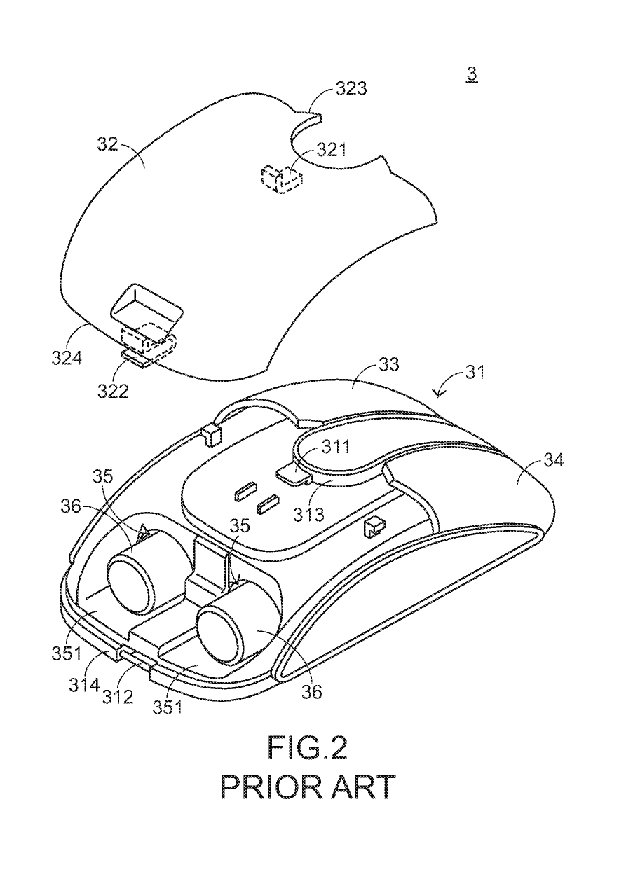

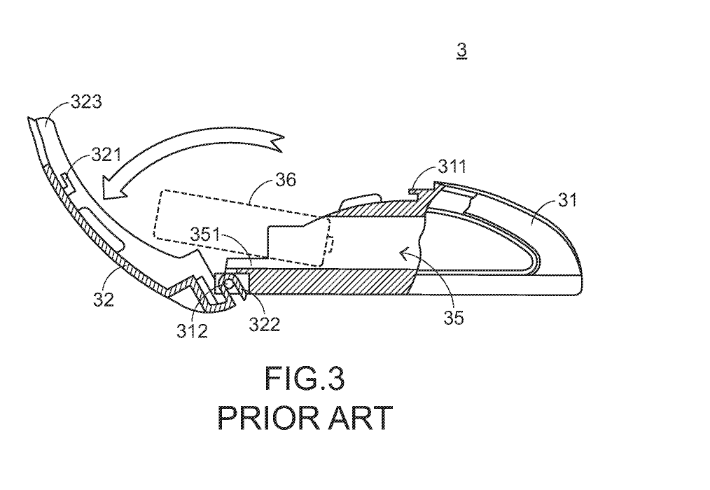

### DETAILED DESCRIPTION OF THE PREFERRED EMBODIMENT

For eliminating the drawbacks encountered from the prior art, the present invention provides a mouse device.

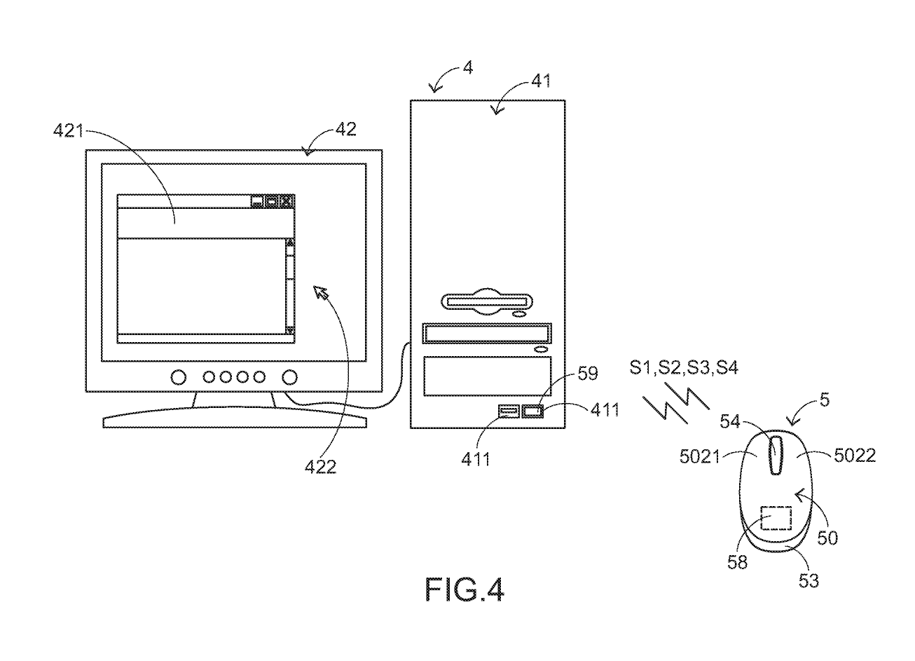

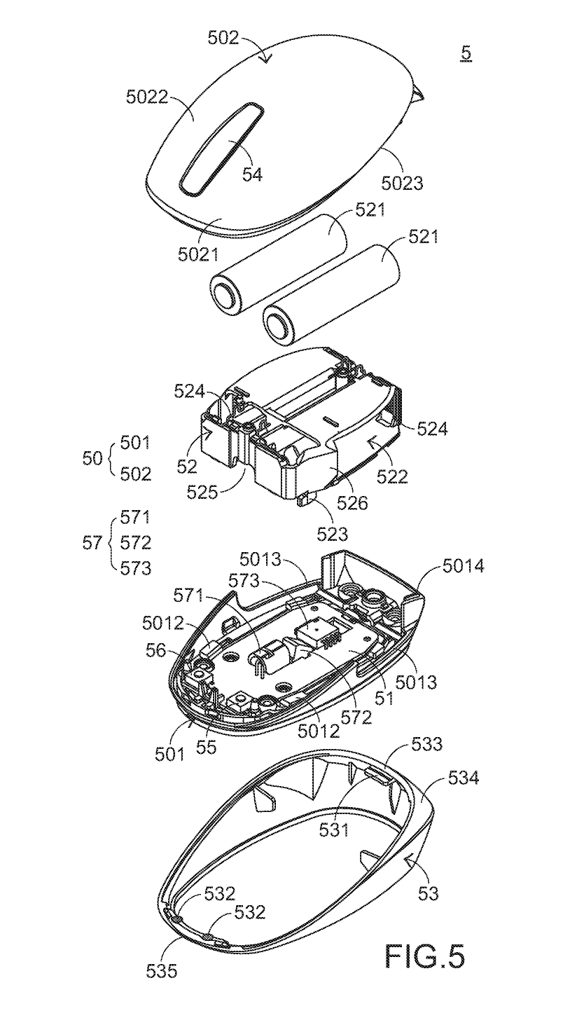

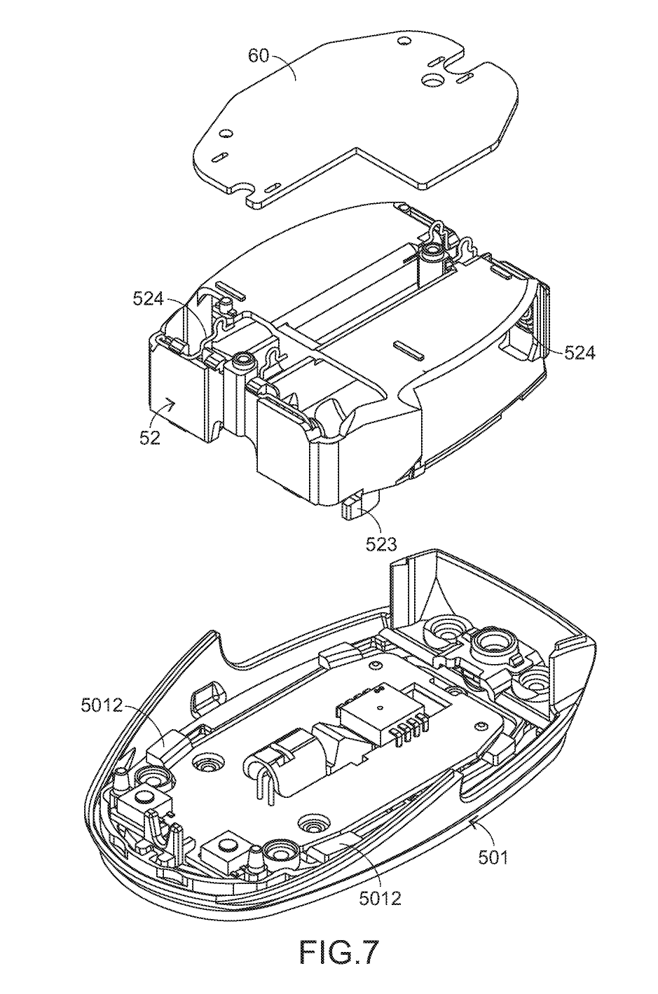

Please refer to FIG. 4 and FIG. 5. FIG. 4 schematically illustrates the connection between a computer system and a mouse device according to an embodiment of the present invention. FIG. 5 is a schematic exploded view illustrating the mouse device according to the embodiment of the present invention. In FIG. 4, a computer system 4 is shown. The computer system 4 comprises a computer host 41 and a display screen 42. The computer host 41 is in communication with a mouse device 5 and the display screen 42. The computer host 41 has a connecting port 411. A graphic-based window 421 and a cursor 422 are shown on the display screen 42. The mouse device 5 is used for controlling a movement of the cursor 422 of the computer host 41. The mouse device 5 comprises a case member 50, a circuit board 51, a battery storage box 52, a ring-shaped cover 53, a scrolling module 54, a first switch 55, a second switch 56, a displacement sensing device 57, a wireless signal transmitter 58, and a wireless signal receiver 59, and an additional circuit board 60 (see FIG. 7). As shown in FIG. 4, the wireless signal transmitter 58 is disposed on the circuit board 51. The wireless signal transmitter 58 is used for receiving plural signals from the scrolling module 54, the first switch 55, the second switch 56 and the displacement sensing device 57. Moreover, the plural signals are transmitted from the wireless signal transmitter 58 to the wireless signal receiver 59 by a wireless transmission technology. The wireless signal receiver 59 is plugged into the connecting port 411 of the computer host 41. The wireless signal receiver 59 is in communication with the wireless signal transmitter 58 by the wireless transmission technology in order to receive the plural signals from the wireless signal transmitter 58. In this embodiment, the wireless signal receiver 59 is connected with the connecting port 411 through a universal series bus (USB) interface.

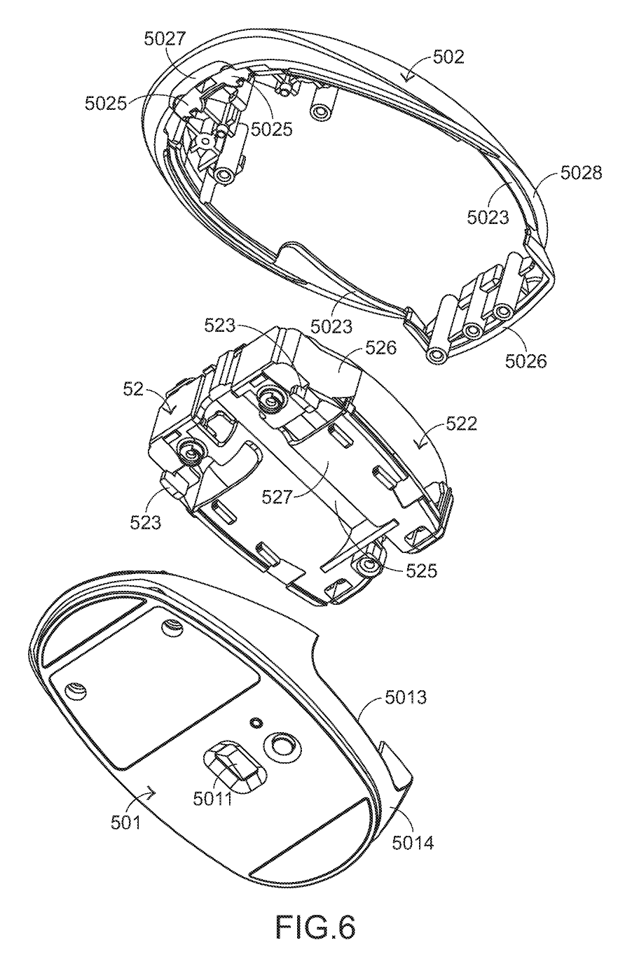

The case member 50 comprises a base 501 and an upper cover 502. The circuit board 51 is disposed on the base 501. The base 501 comprises an opening 5011 (see FIG. 6) and a first fixing structure 5012. The first fixing structure 5012 is used for fixing the battery storage box 52 on the base 501. The upper cover 502 is used for covering the base 501. The scrolling module 54 is disposed on the upper cover 502 and electrically connected with the additional circuit board 60. For clearly showing the components of the mouse device 5, the electric connection relationships between these components are not shown in the drawings. When the scrolling module 54 is triggered by the user's finger, the scrolling module 54 generates a scrolling signal Si to the computer host 41. According to the scrolling signal S1, the computer host 41 executes a scrolling command of scrolling the graphic-based window 421. The upper cover 502 comprises a first button part 5021 and a second button part 5022. The first button part 5021 is located at a first side of the scrolling module 54. The second button part 5022 is located at a second side of the scrolling module 54. In this embodiment, the scrolling module 54 is a touch module. Alternatively, in some other embodiments, the scrolling module is an optical finger navigation (OFN) module or a membrane switch circuit module. When the optical finger navigation (OFN) module or the membrane switch circuit module is triggered by the user's finger, a scrolling signal is generated.

As shown in FIG. 5, the first switch 55 is located at a first side of the circuit board 51, and electrically connected with the circuit board 51. When the first switch 55 is triggered by the first button part 5021 of the upper cover 502, the first switch 55 generates a first button signal S2 to the computer host 41. According to the first button signal S2, the computer host 41 executes a corresponding first button command. The second switch 56 is located at a second side of the circuit board 51, and electrically connected with the circuit board 51. When the second switch 56 is triggered by the second button part 5022 of the upper cover 502, the second switch 56 generates a second button signal S3 to the computer host 41. According to the second button signal S3, the computer host 41 executes a corresponding second button command. In this embodiment, the first button signal S2 is a left button signal, and the first button command is a left button command. Moreover, the second button signal S3 is a right button signal, and the second button command is a right button command.

FIG. 6 is a schematic exploded view illustrating the mouse device according to the embodiment of the present invention and taken along another viewpoint. Please refer to FIGS. 5 and 6. The battery storage box 52 is fixed on the base 501 and disposed over the circuit board 51. The battery storage box 52 is electrically connected with the circuit board 51 for accommodating at least one battery 521. In FIG. 5, two batteries 521 are shown. Moreover, the at least one battery 521 and the circuit board 51 are separated from each other by the battery storage box 52. The battery storage box 52 comprises at least one entrance 522, a second fixing structure 523, plural conducting elements 524, and a groove 525. The at least one entrance 522 is formed in at least one sidewall 526 of the battery storage box 52. Moreover, the at least one entrance 522 is correlated with a corresponding battery 521 and a corresponding sidewall 526 of the battery storage box 52. When the battery storage box 52 is fixed on base 501, the entrance 522 is arranged between a sidewall 5013 of the base 501 and a sidewall 5023 of the upper cover 502. The at least one battery 521 may be transferred through the at least one entrance 522 to be accommodated within the battery storage box 52. Moreover, the at least one battery 521 may be removed from the battery storage box 52 through the at least one entrance 522.

The second fixing structure 523 is disposed on a bottom surface 527 of the battery storage box 52, and located near an edge of the bottom surface 527. When the second fixing structure 523 is connected with the first fixing structure 5012, the battery storage box 52 is fixed on the base 501. After the battery storage box 52 is fixed on the base 501, the electric connection between the at least one battery 521 and the circuit board 51 is established through the plural conducting elements 524 of the battery storage box 52. Consequently, the electric power can be transmitted from the at least one battery 521 to the circuit board 51 through the plural conducting elements 524 in order to permit normal operation of the mouse device 5. The groove 525 is formed in the bottom surface 527 of the battery storage box 52 and located at a middle region of the bottom surface 527 in order to partially accommodate the displacement sensing device 57. In this embodiment, the first fixing structure 5012 is a first fixing hook, the second fixing structure 523 is a second fixing hook, and the plural conducting elements 524 are made of metallic materials.

The displacement sensing device 57 is disposed on the base 501 and disposed under the battery storage box 52. The displacement sensing device 57 is partially exposed outside the opening 5011 of the base 501. The displacement sensing device 57 comprises a light-emitting element 571, an optical assembly 572, and an optical sensing element 573. The light-emitting element 571 is used for emitting a light beam (not shown). The optical assembly 572 is disposed on the base 501, and located near the light-emitting element 571. A part of the optical assembly 572 is accommodated within the groove 525 of the battery storage box 52. The optical assembly 572 is used for allowing the light beam to go through and projecting the light beam on a working surface (not shown). The optical sensing element 573 is located near the optical assembly 572 for receiving the light beam. According to the light beam, the optical sensing element 573 generates a cursor displacement signal S4 to the computer host 41. According to the cursor displacement signal S4, the cursor 422 is correspondingly moved by the computer host 41. That is, when the base 501 is moved on the working surface by the user, the light beam emitted by the light-emitting element 571 is transmitted through the optical assembly 572 to be received by the optical sensing element 573. Consequently, the optical sensing element 573 generates plural working surface images corresponding to respective positions of the mouse device 5. By comparing the plural working surface images with each other, the optical sensing element 573 acquires a displacement amount of the mouse device 5 relative to the working surface. Moreover, according to the displacement amount, the optical sensing element 573 generates the cursor displacement signal S4 to the computer host 41. Moreover, an example of the light-emitting element 571 is a light emitting diode (LED).

In this embodiment, the scrolling signal S1, the first button signal S2, the second button signal S3 and the cursor displacement signal S4 are transmitted to the computer host 41 through the wireless signal transmitter 58 and the wireless signal receiver 59. Alternatively, in some other embodiments, the mouse computer is in communication with the computer host through a connecting wire, and the above signals are transmitted through the connecting wire.

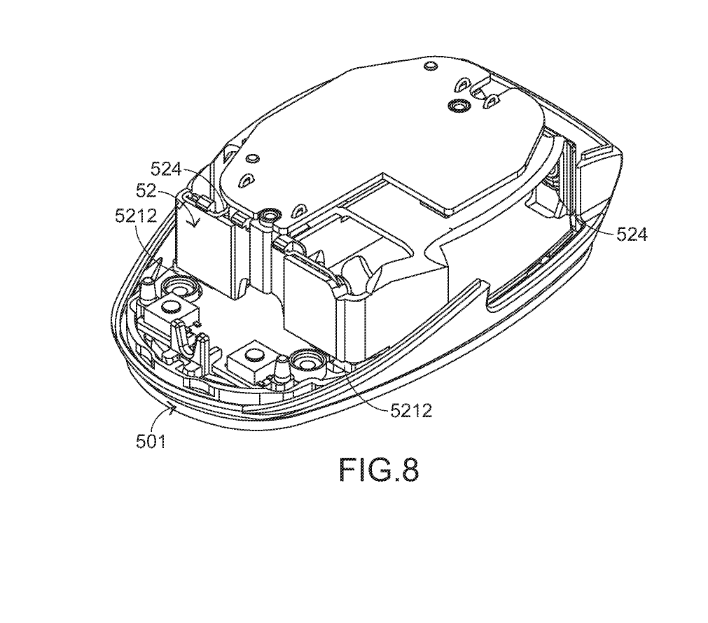

Please refer to FIGS. 7 and 8. FIG. 7 is a schematic exploded view illustrating the battery storage box and the base of the mouse device according to the embodiment of the present invention. FIG. 8 is a schematic assembled view illustrating the battery storage box and the base of the mouse device according to the embodiment of the present invention. As shown in FIG. 7, the battery storage box 52 is separated from the base 501. In a case where the first fixing structure 5012 is disengaged from the second fixing structure 523, the battery storage box 52 can be detached from the base 501. When the first fixing structure 5012 is engaged with the second fixing structure 523, the battery storage box 52 is fixed on the base 501, and the additional circuit board 60 is disposed on the battery storage box 52 (see FIG. 8). According to this design, if the plural conducting elements 524 are suffered from poor contact or damaged, the plural conducting elements 524 can be easily replaced with new ones. Moreover, this design may be applied to both of the wireless mouse device and the wired mouse device. When the battery storage box 52 is fixed on the base 501, the base 501 can be applied to a wireless mouse device. When the battery storage box 52 is detached from the base 501, the base 501 can be applied to a wired mouse device. Since the base can be shared by the wired mouse device and the wireless mouse device, the structure of the base can be adopted by different mouse manufacturers without the need of designing different structures of bases.

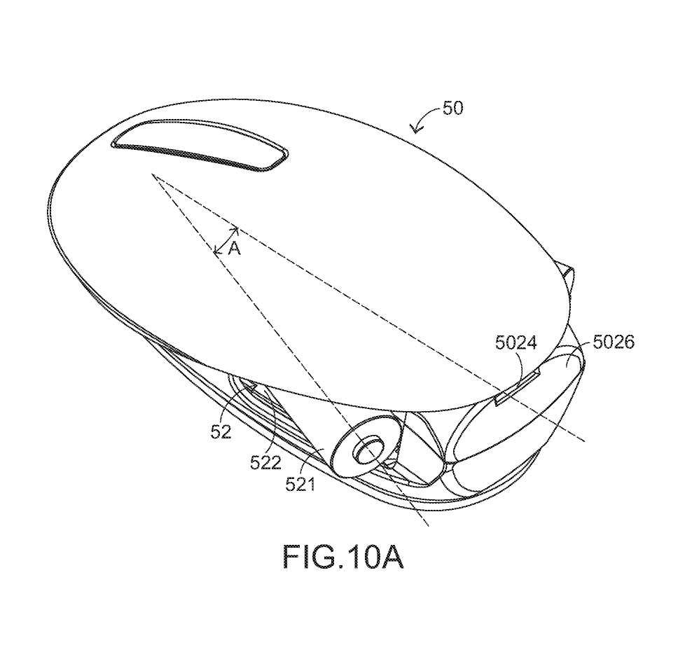

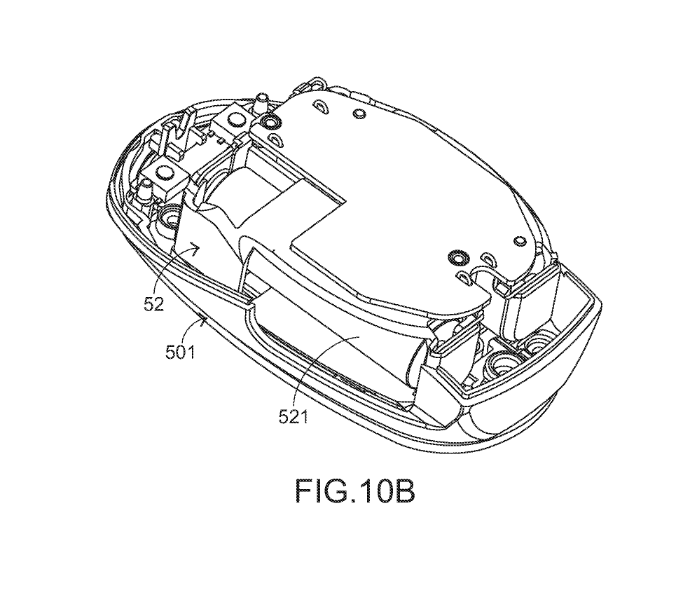

Please refer to FIGS. 5 and 6 again. The upper cover 502 further comprises a third fixing structure 5024 (see FIG. 10A) and a fourth fixing structure 5025. The third fixing structure 5024 is located at a rear end 5026 of the upper cover 502. The fourth fixing structure 5025 is located at a front end 5027 of the upper cover 502. The ring-shaped cover 53 is a ring-shaped structure. A rear end 534 of the ring-shaped cover 53 is formed as a covering structure. The ring-shaped cover 53 is connected with the case member 50 from a rear side of the case member 50 and a bottom side of the case member 50. Consequently, a part of the case member 50 and the at least one entrance 522 of the battery storage box 52 are covered by the ring-shaped cover 53. The ring-shaped cover 53 comprises a fifth fixing structure 531 and a sixth fixing structure 532. The fifth fixing structure 531 is disposed on an upper edge 533 of the ring-shaped cover 53, and located near the rear end 534 of the ring-shaped cover 53. When the upper edge 533 of the ring-shaped cover 53 is contacted with the rear end 5026 of the upper cover 502, the fifth fixing structure 531 is connected with the third fixing structure 5024. The sixth fixing structure 532 is located at a front end 535 of the ring-shaped cover 53. When the front end 535 of the ring-shaped cover 53 is contacted with the front end 5027 of the upper cover 502, the sixth fixing structure 532 is connected with the fourth fixing structure 5025.

In this embodiment, the third fixing structure 5024 is an upper cover indention, the fourth fixing structure 5025 is a magnetic element, the fifth fixing structure 531 is a protrusion, and the sixth fixing structure 532 is another magnetic element to be magnetically attracted with the fourth fixing structure 5025. Alternatively, in some other embodiments, one of the fourth fixing structure and the sixth fixing structure is a magnetic element, and the other one of the fourth fixing structure and the sixth fixing structure is a metallic element to be magnetically attracted by the magnetic element. Alternatively, in some other embodiments, the sixth fixing structure is a hooking structure, and the fourth fixing structure is another upper cover indentation or another hooking structure corresponding to the hooking structure.

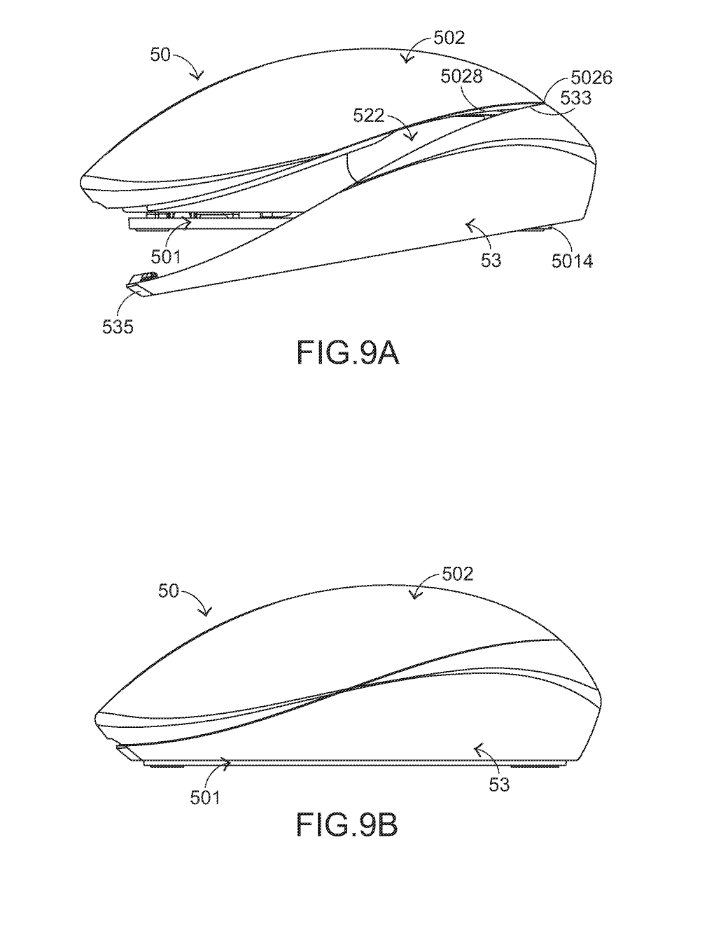

Hereinafter, a process of combining the ring-shaped cover 53 with the case member 50 will be illustrated with reference to FIGS. 5, 6, 9A and 9B. FIGS. 9A and 9B are schematic side views illustrating the combination of the case member and the ring-shaped cover of the mouse device according to the embodiment of the present invention. For combining the ring-shaped cover 53 with the case member 50, the ring-shaped cover 53 is firstly placed near the upper cover 502 from the rear end 5026 of the upper cover 502, and the fifth fixing structure 531 of the ring-shaped cover 53 is inserted into the third fixing structure 5024 of the upper cover 502, so that the fifth fixing structure 531 and the third fixing structure 5024 are connected with each other. Meanwhile, the upper edge 533 of the ring-shaped cover 53 is partially contacted with a lower part 5028 of the upper cover 502, a rear end 5014 of the base 501 is covered by the ring-shaped cover 53, and the sidewall 5013 of the base 501 is partially covered by the ring-shaped cover 53. That is, the at least one entrance 522 of the battery storage box 52 is partially covered by the ring-shaped cover 53 (see FIG. 9A). Then, by swinging the front end 535 of the ring-shaped cover 53, the sixth fixing structure 532 of the ring-shaped cover 53 and the fourth fixing structure 5025 of the upper cover 502 are connected with each other. Meanwhile, the sidewall 5013 of the base 501 and the rear end 5014 of the base 501 are covered by the ring-shaped cover 53, and the at least one entrance 522 is covered by the ring-shaped cover 53, so that the at least one battery 521 is protected by the ring-shaped cover 53. In addition, the upper edge 533 of the ring-shaped cover 53 is completely contacted with the lower part 5028 of the upper cover 502 (see FIG. 9B).

FIGS. 10A and 10B are schematic perspective views illustrating a process of installing a battery in the battery storage box of the mouse device according to the embodiment of the present invention. For placing the battery 521 into the battery storage box 52, the ring-shaped cover 53 is firstly detached from the case member 50, so that the at least one entrance 522 of the battery storage box 52 is exposed outside. Then, an end of the at least one battery 521 is transferred through the at least one entrance 522. Under this circumstance, an angle A is formed between the at least one battery 521 and the battery storage box 52, and the angle A is smaller than 90 degrees (see FIG. 10A). Then, the other end of the at least one battery 521 is pushed into the at least one entrance 522, so that the at least one battery 521 is parallel with the battery storage box 52 (see FIG. 10B). Finally, the ring-shaped cover 53 and the case member 50 are combined together by the process as shown in FIGS. 9A and 9B. The steps of removing the at least one battery 521 from the battery storage box 52 are reverse to the steps of placing the at least one battery 521 into the battery storage box 52, and are not redundantly described herein.

From the above descriptions, the mouse device of the present invention comprises the battery storage box for accommodating the battery. Moreover, the battery and the circuit board are separated from each other by the battery storage box, so that the battery and the circuit board are not contacted with each other. Moreover, the entrance of the battery storage box is formed in the sidewall of the battery storage box. In the mouse device of the present invention, the ring-shaped cover is connected with the case member from a rear side and a bottom side of the case member, so that the entrance of the battery storage box is covered by the ring-shaped cover and the battery is protected by the ring-shaped cover. Since the mouse device of the present invention has no rotating shaft and no battery cover at the rear end of the case member, the length of the mouse device of the present invention is shorter than the length of the conventional mouse device. Consequently, the volume of the mouse device of the present invention is reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mouse device, comprising:
a case member;
a circuit board disposed within said case member;
a battery storage box fixed on said case member and disposed over said circuit board, wherein said battery storage box is electrically connected with said circuit board for accommodating a battery, and said battery and said circuit board are separated from each other by said battery storage box, wherein said battery storage box has an entrance, and said entrance is formed in a sidewall of said battery storage box, wherein said battery is permitted to be transferred through said entrance to be accommodated within said battery storage box, or said battery is permitted to be removed from said battery storage box through said entrance; and
a ring-shaped cover connected with said case member from a rear side of said casing and a bottom side of said case member, so that a part of said case member and said entrance are covered by said ring-shaped cover, wherein after said battery is accommodated within said battery storage box, said battery is parallel with said battery storage box, wherein during said battery is transferred through said entrance, an angle is formed between said battery and battery storage box, and said angle is smaller than 90 degrees.

2. The mouse device according to claim 1, wherein said case member comprises:
a base, wherein said circuit board is disposed on said base, and said base comprises a first fixing structure for fixing said battery storage box on said base; and
an upper cover for covering said base, wherein said entrance is arranged between a sidewall of said base and a sidewall of said upper cover.

3. The mouse device according to claim 2, wherein said battery storage box further comprises:
a second fixing structure disposed on a bottom surface of said battery storage box, wherein when said second fixing structure is connected with said first fixing structure, said battery storage box is fixed on said base; and
plural conducting elements, wherein after said battery storage box is fixed on said base, electric connection between said battery and said circuit board is established through said plural conducting elements, so that electric power is transmitted from said battery to said circuit board through said plural conducting elements.

4. The mouse device according to claim 3, wherein said first fixing structure is a first fixing hook, and said second fixing structure is a second fixing hook, wherein when said first fixing hook and said second fixing hook are disengaged from each other, said battery storage box is detachable from said base, wherein when said first fixing hook and said second fixing hook are engaged with each other, said battery storage box is fixed on said base.

5. The mouse device according to claim 2, wherein said upper cover comprises a third fixing structure and a fourth fixing structure, said third fixing structure is located at a rear end of said upper cover, and said fourth fixing structure is located at a front end of said upper cover, wherein said ring-shaped cover comprises a fifth fixing structure and a sixth fixing structure, said fifth fixing structure is disposed on an upper edge of said ring-shaped cover and located near a rear end of said ring-shaped cover, said fifth fixing structure is connected with said third fixing structure when said upper edge of said ring-shaped cover is contacted with said rear end of said upper cover, said sixth fixing structure is located at a front end of said ring-shaped cover, and said sixth fixing structure is connected with said fourth fixing structure when said front end of said ring-shaped cover is contacted with said front end of said upper cover.

6. The mouse device according to claim 5, wherein after said third fixing structure is connected with said fifth fixing structure and said fourth fixing structure is connected with said sixth fixing structure, said sidewall of said base and a rear end of said base are covered by said ring-shaped cover, said entrance is covered by said ring-shaped cover such that said battery is protected by said ring-shaped cover, and said upper edge of said ring-shaped cover is contacted with a lower part of said upper cover.

7. The mouse device according to claim 2, further comprising a displacement sensing device, wherein said displacement sensing device is disposed on said base, located under said battery storage box, and exposed outside an opening said base for generating a cursor displacement signal in response to a movement of said base on a working surface, wherein according to said cursor displacement signal, a movement of said cursor of a computer system is correspondingly controlled, wherein said displacement sensing device comprises:
a light-emitting element for emitting a light beam;
an optical assembly disposed on said base and located near said light-emitting element for allowing said light beam to go through and projecting said light beam on said working surface; and
an optical sensing element located near said optical assembly for receiving said light beam, and generating said cursor displacement signal according to said light beam.

8. The mouse device according to claim 7, wherein said battery storage box further comprises a groove, wherein said groove is formed in a bottom surface of said battery storage box for partially accommodating said optical assembly.

9. The mouse device according to claim 7, further comprising:
a scrolling module disposed on said upper cover, wherein when said scrolling module is triggered, said scrolling module generates a scrolling signal to said computer system;
a first switch located at a first side of said circuit board and electrically connected with said circuit board, wherein when said first switch is triggered, said first switch generates a first button signal to said computer system; and
a second switch located at a second side of said circuit board and electrically connected with said circuit board, wherein when said second switch is triggered, said second switch generates a second button signal to said computer system.

10. The mouse device according to claim 9, wherein said scrolling module is a touch module, an optical finger navigation (OFN) module or a membrane switch circuit module.
